(19) United States
(12) Patent Application Publication
(10) Pub. No.: US 2025/0378820 A1
(43) Pub. Date: Dec. 11, 2025

(54) SPEECH ENCODING MODEL TRAINING

(71) Applicants: Beijing Zitiao Network Technology Co., Ltd., Beijing (CN); Lemon Inc., Grand Cayman (KY)

(72) Inventors: Zehua Lin, Beijing (CN); Mingkun Huang, Beijing (CN); Ye Bai, Beijing (CN); Youjia Huang, Beijing (CN); Minglun Han, Beijing (CN); Lu Lu, Los Angeles, CA (US)

(21) Appl. No.: 19/233,615

(22) Filed: Jun. 10, 2025

(30) Foreign Application Priority Data
Jun. 11, 2024 (CN) 202410749776.7

(51) Int. Cl. G10L 15/06; G10L 15/02; G10L 15/04; G10L 15/183; G10L 25/18

(52) U.S. Cl. CPC G10L 15/063; G10L 15/02; G10L 15/04; G10L 15/183; G10L 25/18; G10L 2015/0631; G10L 2015/0635

(57) ABSTRACT

Embodiments of the disclosure relate to a method, an apparatus, a device and a readable medium for training a speech encoding model. An example method includes: processing, by using a first speech encoding model, a speech feature representation of a speech sample to generate a set of discrete features; generating label information based on the set of discrete features, the label information comprising a set of labels indicating a clustering center corresponding to a respective discrete feature; processing, by using a second speech encoding model, an intermediate feature representation generated based on the speech feature representation to generate probability information corresponding to the label information; determining a training loss based on the label information, the probability information, and weight information determined based on a distance from a respective discrete feature to a corresponding clustering center; and adjusting a parameter of the second speech encoding model based on the training loss.

### CROSS-REFERENCE

The present application claims priority to Chinese Patent Application No. 202410749776.7, filed on Jun. 11, 2024, and entitled “METHOD, APPARATUS, DEVICE AND READABLE MEDIUM FOR TRAINING SPEECH ENCODING MODEL”, which is incorporated herein by reference in its entirety.

### FIELD

Example embodiments of the present disclosure generally relate to the field of computer technical, and more particularly, to speech encoding model training.

### BACKGROUND

With the development of Internet technology, more and more applications or platforms and the like provide a function for natural language processing, which brings many conveniences to a large number of users. An application or platform having the function for natural language processing may provide a service for natural language processing to a user based on a trained machine learning model. Speech recognition tasks are important tasks in tasks for natural language processing. It is expected that the model capability of the machine learning model can be improved to improve the quality of the service for natural language processing.

### SUMMARY

In a first aspect of the present disclosure, a method for training a speech encoding model is provided. The method includes: processing, by using a first speech encoding model, a speech feature representation of a speech sample to generate a set of discrete features; generating label information based on the set of discrete features, the label information including a set of labels indicating a clustering center corresponding to a respective discrete feature; processing, by using a second speech encoding model, an intermediate feature representation generated based on the speech feature representation to generate probability information corresponding to the label information; determining a training loss based on the label information, the probability information, and weight information determined based on a distance from a respective discrete feature to a corresponding clustering center; and adjusting a parameter of the second speech encoding model based on the training loss.

In a second aspect of the present disclosure, an apparatus for training a speech encoding model is provided. The apparatus includes: a discrete feature generation module configured to process, by using a first speech encoding model, a speech feature representation of a speech sample to generate a set of discrete features; a label information generation module configured to generate label information based on the set of discrete features, the label information including a set of labels indicating a clustering center corresponding to a respective discrete feature; and a probability information generation module configured to process, by using a second speech encoding model, an intermediate feature representation generated based on the speech feature representation to generate probability information corresponding to the label information; a training loss determination module configured to determine a training loss based on the label information, the probability information, and weight information determined based on a distance from a respective discrete feature to a corresponding clustering center; and a model parameter adjustment module configured to adjust a parameter of the second speech encoding model based on the training loss.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium having stored thereon a computer program executable by the processor to implement the method of the first aspect.

In a fifth aspect of the present disclosure, a computer program product is provided. The computer program product includes computer-executable instructions that, when executed by a processor, implement the method of the first aspect.

It should be understood that the content described in the content part of the present disclosure is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1A illustrates a schematic diagram of an example environment in which embodiments of the present disclosure can be implemented;

FIG. 1B illustrates a schematic diagram of an example of a model according to some embodiments of the present disclosure;

FIG. 2 illustrates a schematic diagram of an example architecture for training a speech encoding model according to some embodiments of the present disclosure;

FIG. 3 illustrates a schematic diagram of an example according to some embodiments of the present disclosure;

FIG. 4 illustrates a flowchart of a process for training a speech encoding model according to some embodiments of the present disclosure;

FIG. 5 illustrates a schematic structural block diagram of an apparatus for training a speech encoding model according to some embodiments of the present disclosure; and

FIG. 6 illustrates a block diagram of a computing device in which one or more embodiments of the present disclosure may be implemented.

### DETAILED DESCRIPTION

Embodiments of the present disclosure will be described in more detail below with reference to the accompanying drawings. While some embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

It should be noted that, in the technical solutions of the present disclosure, the acquired personal information of the user is obtained, stored and applied, etc., all meet the provisions of related laws and regulations, and do not violate the public key.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user is obtained.

For example, in response to receiving an active request from a user, prompt information is sent to the user to explicitly prompt the user that the requested operation will need to obtain and use personal information of the user, so that the user can autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “disagree” to provide personal information to the electronic device.

It may be understood that the foregoing notification and obtaining user authorization processes are merely illustrative, and do not constitute a limitation on the embodiments of the present disclosure, and other manners of meeting related laws and regulations may also be applied to the embodiments of the present disclosure.

As used herein, the term “model” may learn an association relationship between respective inputs and outputs from training data such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, increasing the depth of the network. Each layer of the neural network is connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may generally include three phases, a training phase, a testing phase, and an application phase (also referred to as an inference phase). At the training stage, a given model may be trained using a large amount of training data, constantly updating the parameter values, until the model is able to obtain consistent inferences from the training data that satisfy the expected objectives. By training, the model may be considered to be able to learn, from the training data, an association from input to output (also referred to as mapping of input to output). The parameter values of the trained model are determined. In the testing phase, the test input is applied to the trained model, and the test model can provide correct output, thereby determining the performance of the model. In the application stage, the model may be used to process the actual input based on the parameter value obtained by training to determine a corresponding output.

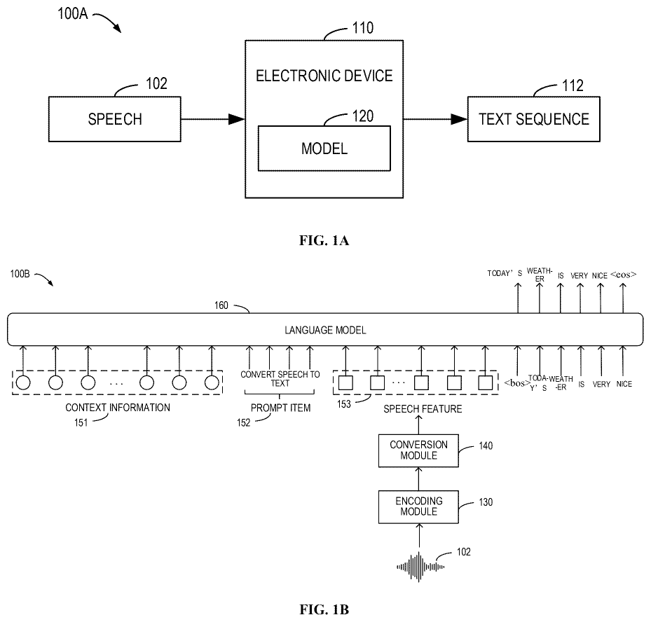

FIG. 1A illustrates a schematic diagram of an example environment 100A in which embodiments of the present disclosure can be implemented. As shown in FIG. 1A, the environment 100A may include an electronic device 110.

The electronic device 110 may, for example, convert a speech 102 into a text sequence 112 that matches the speech 102. That is, the electronic device 110 may perform a speech recognition task on the speech 102 to generate a corresponding text sequence 112. The speech 102 herein may be any suitable language and any duration of speech. The electronic device 110 may perform speech recognition on the speech 102 to generate a text sequence of a corresponding language. For example, the electronic device 110 may recognize a speech whose language is English to generate a text sequence whose language is English. The speech 102 may be a speech local to the electronic device 110, or may be a speech acquired by the electronic device 110 in real time.

The electronic device 110 may, for example, use a trained model 120 (e.g., may be a machine learning model) to perform a speech recognition task. The model 120 may be a model local to the electronic device 110, or may be a model installed on another electronic device 110 (for example, installed in a remote device). The model 120 may include one or more models. If the model 120 includes a plurality of models, the plurality of models may include a same model or different models.

The electronic device 110 may include any computing system having computing capabilities, such as various computing devices/systems, terminal devices, server devices, and the like. The terminal device may be any type of mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camera, a positioning device, a television receiver, a radio broadcast receiver, an electronic book device, a game device, or any combination thereof, including accessories and peripherals of these devices, or any combination thereof.

The server device may be a standalone physical server, or may be a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server device may include, for example, a computing system/server, such as a mainframe, an edge computing node, a computing device in a cloud environment, or the like.

It should be understood that the structure and function of a respective element in environment 100A is described for illustrative purposes only, and does not imply any limitation on the scope of the present disclosure.

FIG. 1B illustrates a schematic diagram of an example 100B of a model, such as the model 120, according to some embodiments of the present disclosure. The example 100B relates to an encoding model 130, a conversion model 140, and a language model 160. The encoding model 130 may encode the speech 102 into a speech feature. The conversion model 140 may further convert the speech feature to a dimension that the language model 160 may process to obtain a converted speech feature 153. The converted speech feature 153 may also be referred to as a speech embedding, or a set of tokens. The input of the language model 160 includes context information 151, which may include content of historical conversations, a description of a scenario for a speech, or any information that may be helpful for speech recognition. Input of the language model 160 may also include a prompt item 152, which may be used to indicate the language model 160 to perform a speech recognition task. In some scenarios, the prompt item 152 may also indicate other tasks, for example, may also indicate a task for language recognition. In addition, the input of the language model 160 may further include a converted speech feature 153.

The language model 160 may be executed based on a next token prediction, NTP. In FIG. 1B, <bos> represents a beginning of sentence, which is a marker, and <eos> represents an end of sentence, which is also a marker. Every time when a prediction is made, the language model 160 may output a token (e.g., a Chinese character or a word). When the next token is predicted, the previously generated token may be taken as the basis for the language model 160 to predict a next token. For example, when completing a prediction for a token “weather”, the language model 160 may predict the token “weather” based on a token “today's” that has been generated.

As briefly mentioned above, an application or platform having a function for natural language processing may provide a service for natural language processing to a user based on a trained machine learning model, such as a speech encoding model. Speech recognition tasks are important tasks in tasks for natural language processing. With a continuous progress and popularization of artificial intelligence technology, the expectations for the effect of speech recognition are also increasing. It is desirable that the machine learning model be better trained to provide the model capability of the machine learning model.

Traditionally, in order to improve the model capability, the speech encoding model is usually trained by unsupervised pre-training. Training based on a discrete label is the most common class of methods for unsupervised pre-training. Specifically, the speech segment information may be quantized to the discrete label, and a mapping relationship between a model speech segment to the discrete label causes the speech encoding model to have a capability of modeling speech information. However, since the discrete label itself has information loss, this may lead to a defect that the speech encoding model obtained by a pre-training method based on the discrete label has weak anti-noise capability and is easy to overfit.

In view of this, embodiments of the present disclosure provide a method for training a speech encoding model. The method includes: processing, by using a first speech encoding model, a speech feature representation of a speech sample to generate a set of discrete features. Label information is generated based on the set of discrete features. The label information includes a set of labels indicating a clustering center corresponding to a respective discrete feature. An intermediate feature representation generated based on the speech feature representation is processed by using a second speech encoding model to generate probability information corresponding to the label information. A training loss is determined based on the label information, the probability information, and weight information determined based on a distance from a respective discrete feature to a corresponding clustering center. A parameter of the second speech encoding model is adjusted based on the training loss.

In this way, in embodiments of the present disclosure, the second speech encoding model may be trained through the trained speech encoding model, the second speech encoding model may be trained by using only speech samples including a small amount of data, the amount of data required for training is reduced, the stability for the training process of the unsupervised model is also improved, the training effect of the model is improved, and the model capability is further improved.

Some example embodiments of the present disclosure will be described below with continued reference to the accompanying drawings.

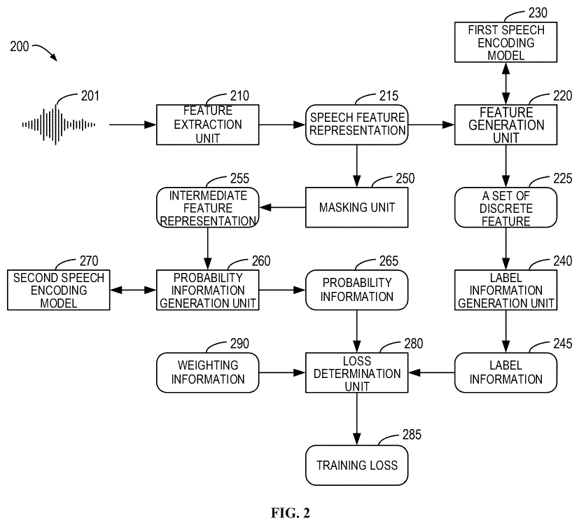

FIG. 2 illustrates a schematic diagram of an example architecture 200 for training a speech encoding model, such as the encoding model 130, in accordance with some embodiments of the present disclosure. The example architecture 200 may be implemented at the electronic device 110. For ease of discussion, architecture 200 will be described with reference to environment 100 of FIG. 1.

As shown in FIG. 2, the architecture 200 relates to a feature extraction unit 210, a feature generation unit 220, a label information generation unit 240, a masking unit 250, a probability information generation unit 260, and a loss determination unit 280. The feature extraction unit 210 may extract a speech feature representation 215 of a speech sample 201. For example, the feature extraction unit 210 may encode the speech sample 201 to determine the speech feature representation 215 of the speech sample 201. The speech feature representation 245 includes, for example, spectral features of the speech sample 201. The feature generation unit 220 may determine, based on the speech feature representation 215, a set of discrete features corresponding to the speech sample 201. Specifically, the feature generation unit 220 may determine a plurality of segments of the speech sample 201. The plurality of segments may have a same duration. For example, if the speech sample 201 corresponds to 100 seconds, each segment may correspond to 10 seconds of the speech.

The feature generation unit 220 may generate, based on the speech feature representation 215, a plurality of segment feature representations corresponding to the plurality of segments of the speech sample 201. The feature generation unit 220 may process the plurality of segment feature representations by using the first speech encoding model 230 to generate a set of discrete features 225 corresponding to the plurality of segment feature representations. A set of discrete features may include, for example, results output by an intermediate layer of the first speech encoding model 230. The first speech encoding model 230 may have any suitable model structure. The first speech encoding model 230 includes a speech encoding model determined based on a random discrete label pre-training (Best-RQ) process.

For example, if the plurality of segments of the speech sample 201 are

$${S}^{i} = [ {s}_{1}^{i} , {s}_{2}^{i} , … , {s}_{t}^{i} ]$$

(where the t is the number of the segments, and the plurality of segments have a same duration), the feature generation unit 220 may determine a plurality of segment feature representations corresponding to the plurality of segments, and may process the plurality of segment feature representations by using the first speech encoding model 230 to generate a set of intermediate layer features

$${F}^{i} = [ {f}_{1}^{i} , {f}_{2}^{i} , … , {f}_{t}^{i} ]$$

corresponding to the plurality of segment feature representations. The intermediate layer feature Fⁱ is the result of the intermediate layer output of the first speech encoding model 230. Similarly, the feature generation unit 220 may further generate other features corresponding to the plurality of segment features, and the other features may jointly form a feature set F with the intermediate layer feature Fⁱ, that is, the feature set F is the set of discrete features 225.

The label information generation unit 240 may generate label information 245 based on a set of discrete features 225. The label information 245 may include a set of labels, for example, which may indicate a clustering center corresponding to a respective discrete feature. In some embodiments, the label information generation unit 240 may determine a plurality of clustering centers by clustering the set of discrete features 225. The label information generation unit 240 may cluster the set of discrete features 225 in any suitable manner. For example, the label information generation unit 240 clusters the set of discrete features 225 based on a K-means algorithm to determine a plurality of clustering centers C=[C₁, C₂, . . . , Cₙ], where n is the number of clustering centers.

The label information generation unit 240 may determine the set of labels corresponding to the set of discrete features 225 based on, for example, distances from the set of discrete features 225 to the plurality of clustering centers. For example, taking a set of discrete features 225 F=[F₁, F₂, . . . , Fₜ] as an example, the label information generation unit 240 may obtain a distance vector Dᵢ={dᵢⱼ} based on a distance from each discrete feature Fᵢ to each clustering center Cⱼ, where dᵢⱼ represents a distance from the i-th discrete feature to the j-th clustering center. In some embodiments, the label information generation unit 240 may further determine L=[l₁, l₂, . . . lₜ] representing a category of the closest clustering center to each discrete feature in the set of discrete features 225.

Alternatively or additionally, in addition to determining the clustering center by itself, in some embodiments, the label information generation unit 240 may further determine a set of labels corresponding to the set of discrete features 225 based on distances from the set of discrete features 225 to a plurality of preset clustering centers. The plurality of preset clustering centers may be, for example, a plurality of clustering centers determined historically based on the foregoing manner. For example, it may be a clustering center determined by previous rounds in multi-round training. The plurality of preset clustering centers may also be, for example, a plurality of clustering centers specified by a user.

The masking unit 250 may generate intermediate feature representation 255 based on the speech feature representation 215. Specifically, the masking unit 250 may apply a target mask to the speech feature representation 215 to generate the intermediate feature representation 255. The target mask indicates that feature values of one or more segments of the speech feature representation 215 are set to a predetermined value (e.g., 0).

The probability information generation unit 260 may process the intermediate feature representation 255 by using the second speech encoding model 270 to generate probability information 265 corresponding to the label information 245. The second speech encoding model 270 may also have any suitable model structure. For example, the second speech encoding model 270 may be regarded as a speech encoding model determined by a multi-round training (Hubert) process of K-means clustering based on speech spectrum features. The probability information 265 may include a set of probabilities.

The loss determination unit 280 may determine a training loss 285 based on the label information 245, the probability information 265, and weight information 290. The weight information 290 may be determined based on a distance from a respective discrete feature in the set of discrete features 225 to a corresponding clustering center. In some embodiments, the loss determination unit 280 may determine a cross entropy of the label information 245 and the probability information 265. The loss determination unit 280 may also determine a set of weighting coefficients corresponding to the set of labels included in the label information 245 based on the weight information 290. The loss determination unit 280 may, in turn, determine the training loss 285 based on the cross entropy and the set of weighting coefficients. For example, the loss determination unit 280 may determine the training loss 285 based on the following formula:

$$w = F \cdot softmax ( - {D}_{i} , dim = - 1 ) \qquad ( 1 )$$

$$loss = \sum w \times CrossEntropy ( logit , L ) \qquad ( 2 )$$

The w is a weighting coefficient, the F is a set of discrete features 225, and the Dᵢ is a distance vector obtained based on a distance from each discrete feature Fᵢ to each clustering center Cⱼ. Since the distance vector is a two-dimensional vector, the first dimension of the two-dimensional vector is the number of frames of the speech sample 201, and the second dimension is the number of the points of each clustering center, dim=−1 indicates that all points of the clustering centers are involved in the calculation for each frame, that is, indicates that the obtained weighting coefficient is for each category of the clustering. The negative sign “−” in front of Dᵢ indicates that the target weighting coefficient corresponding to the target label is negatively correlated with the distance from the target label to the corresponding target clustering center. loss is a training loss 285, CrossEntropy is a cross entropy loss function, and L is a category of the closet clustering center in the plurality of clustering centers to each discrete feature, logit is an output of a last layer of the model.

The electronic device 110 may adjust a parameter of the second speech encoding model 270 based on the training loss 285. It should be noted that, in the process of training the second speech encoding model 270, the label information generation unit 240 may be, for example, formed by the first speech encoding model 230 and the clustering center, and which may also be referred to as a discrete label generator. For example, when the label information generation unit 240 clusters a set of discrete features 225 based on a K-means algorithm to determine a plurality of clustering centers, the label information generation unit 240 may be referred to as a K-means discrete label generator T. In some embodiments, if the structures of the second speech encoding model 270 and the first speech encoding model 230 are the same, the electronic device 110 may further initialize the second speech encoding model 270 by using a parameter of the first speech encoding model 230 to improve the convergence rate.

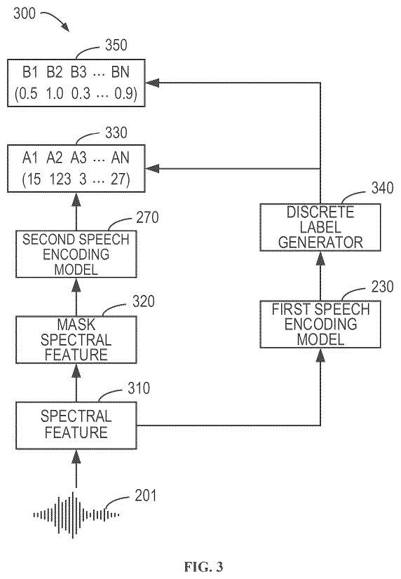

Referring to FIG. 3, FIG. 3 is a schematic diagram of an example 300 according to some embodiments of the present disclosure. As shown in FIG. 3, after the electronic device 110 obtains the speech sample 201, a spectral feature 310 of the speech sample 201 may be determined. The electronic device 110 may process the spectral features 310 by using the first speech encoding model 230 to generate a set of discrete features. The discrete label generator 340 may generate label information 330 based on a set of discrete features. The label information 330 includes a set of labels (e.g., A1 A2 A3 . . . AN), which may indicate a clustering center corresponding to the respective discrete feature. For example, the discrete label generator 340 may be formed by the first speech encoding model 230 and the clustering centers corresponding to the set of discrete features.

The electronic device 110 may apply a target mask to the spectral feature 310 to generate the mask spectral feature 320. The mask spectral feature 320 may be regarded as an intermediate feature representation generated based on the spectral feature 310. The electronic device 110 may process the mask spectral feature 320 by using the second speech encoding model 270 to generate probability information corresponding to the label information. The electronic device 110 may determine a weighting coefficient 350 corresponding to a set of labels based on weight information determined based on the distance from a respective discrete feature to the corresponding clustering center. The weighting coefficient 350 may also include a set of weighting coefficients (e.g., B1 B2 B3 . . . BN). For example, if a set of labels is (15 123 3 . . . 27), the set of weighting coefficients may be (0.5 1.0 0.3 . . . 0.9). The electronic device 110 may determine the training loss based on determining the cross entropy of the label information 330 and the probability information, and the weighting coefficient 350, and adjust a parameter of the second speech encoding model 270 based on the training loss.

In some embodiments, after the training of second speech encoding model is complete, the electronic device 110 may further process the target speech by using the trained second speech encoding model to generate a target feature representation of the target speech, and process the target feature representation by using a speech decoding model to generate a speech recognition result of the target speech. The speech decoding model may also have any suitable model structure, which may include, for example, a language model.

In conclusion, in embodiments of the present disclosure, the second speech encoding model may be trained through the trained speech encoding model, the second speech encoding model may be trained by using only speech samples including a small amount of data, the amount of data required for training is reduced, the stability for the training process of the unsupervised model is also improved, the training effect of the model is improved, and the model capability is further improved.

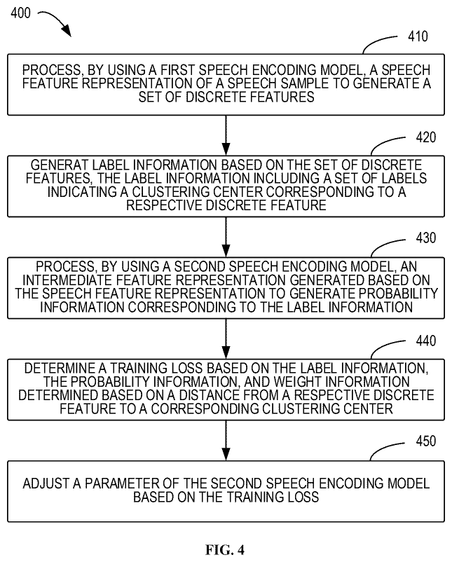

FIG. 4 shows a flowchart of a process 400 for training a speech encoding model according to some embodiments of the present disclosure. The process 400 may be implemented at electronic device 110.

At block 410, the electronic device 110 processes, by using a first speech encoding model, a speech feature representation of a speech sample to generate a set of discrete features.

At block 420, the electronic device 110 generates label information based on the set of discrete features, the label information including a set of labels indicating a clustering center corresponding to a respective discrete feature.

At block 430, the electronic device 110 processes, by using a second speech encoding model, an intermediate feature representation generated based on the speech feature representation to generate probability information corresponding to the label information.

At block 440, the electronic device 110 determines a training loss based on the label information, the probability information, and weight information determined based on a distance from a respective discrete feature to a corresponding clustering center.

At block 450, the electronic device 110 adjusts a parameter of the second speech encoding model based on the training loss.

In some embodiments, determining the training loss based on the label information, the probability information, and the weight information includes: determining a cross entropy of the label information and the probability information; determining, based on the weight information, a set of weighting coefficients corresponding to the set of labels; and determining the training loss based on the cross entropy and the set of weighting coefficients.

In some embodiments, a target weighting coefficient corresponding to a target label is negatively correlated with a distance from the target label to a corresponding target clustering center.

In some embodiments, processing, by using the first speech encoding model, the speech feature representation of the speech sample, includes: generating, based on the speech feature representation, a plurality of segment feature representations corresponding to a plurality of segments of the speech sample; and processing, by using the first speech encoding model, the plurality of segment feature representations to generate the set of discrete features corresponding to the plurality of segment feature representations, the set of discrete features including a result output by an intermediate layer of the first speech encoding model.

In some embodiments, the process 400 further includes: applying a target mask to the speech feature representation to generate the intermediate feature representation.

In some embodiments, the speech feature representation includes a spectral feature of the speech sample.

In some embodiments, the first speech encoding model includes a speech encoding model determined based on a stochastic discrete label pre-training process, and generating the label information based on the set of discrete features includes: determining a plurality of clustering centers by clustering the set of discrete features; and determine the set of labels corresponding to the set of discrete features based on distances from the set of discrete features to the plurality of clustering centers.

In some embodiments, generating the label information based on the set of discrete features includes: determining the set of labels corresponding to the set of discrete features based on distances from the set of discrete features to a plurality of preset clustering centers.

In some embodiments, the process 400 further includes: processing target speech by using the trained second speech encoding model to generate a target feature representation of the target speech; and processing the target feature representation by using a speech decoding model to generate a speech recognition result of the target speech.

In some embodiments, the speech decoding model includes a language model.

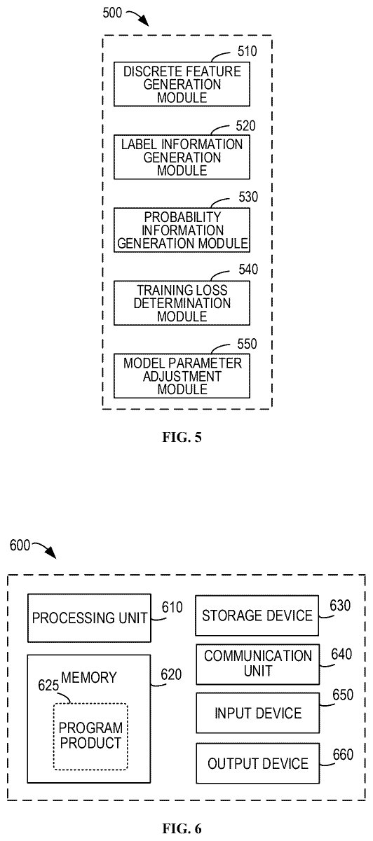

Embodiments of the present disclosure also provide a corresponding apparatus for implementing the above method or process. FIG. 5 is a schematic structural block diagram of an apparatus 500 for training a speech encoding model according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes a discrete feature generation module 510 configured to process, by using a first speech encoding model, a speech feature representation of a speech sample to generate a set of discrete features. The apparatus 500 further includes a label information generation module 520 configured to generate label information based on the set of discrete features, the label information including a set of labels indicating a clustering center corresponding to a respective discrete feature. The apparatus 500 further includes a probability information generation module 530 configured to process, by using a second speech encoding model, an intermediate feature representation generated based on the speech feature representation to generate probability information corresponding to the label information. The apparatus 500 further includes a training loss determination module 540 configured to determine a training loss based on the label information, the probability information, and weight information determined based on a distance from a respective discrete feature to a corresponding clustering center. The apparatus 500 further includes a model parameter adjustment module 550 configured to adjust a parameter of the second speech encoding model based on the training loss.

In some embodiments, the training loss determination module 540 includes: a first determination module configured to determine a cross entropy of the label information and the probability information; a weighting coefficient determination module configured to determine, based on the weight information, a set of weighting coefficients corresponding to the set of labels; and a second determination module configured to determine the training loss based on the cross entropy and the set of weighting coefficients.

In some embodiments, a target weighting coefficient corresponding to a target label is negatively correlated with a distance from the target label to a corresponding target clustering center.

In some embodiments, the discrete feature generation module 510 includes: a segment feature representation generation module configured to generate, based on the speech feature representation, a plurality of segment feature representations corresponding to a plurality of segments of the speech sample; and a segment feature representation processing module configured to process, by using the first speech encoding model, the plurality of segment feature representations to generate the set of discrete features corresponding to the plurality of segment feature representations, the set of discrete features including a result output by an intermediate layer of the first speech encoding model.

In some embodiments, the apparatus 500 further includes a masking module configured to apply a target mask to the speech feature representation to generate the intermediate feature representation.

In some embodiments, the speech feature representation includes a spectral feature of the speech sample.

In some embodiments, the first speech encoding model includes a speech encoding model determined based on a stochastic discrete label pre-training process, and the label information generation module 520 includes: a clustering center determination module configured to determine a plurality of clustering centers by clustering the set of discrete features; and a label determination module configured to determine the set of labels corresponding to the set of discrete features based on distances from the set of discrete features to the plurality of clustering centers.

In some embodiments, the label information generation module 520 includes: a third determination module configured to determine the set of labels corresponding to the set of discrete features based on distances from the set of discrete features to a plurality of preset clustering centers.

In some embodiments, the apparatus 500 further includes: a target feature representation generation module configured to process target speech by using the trained second speech encoding model to generate a target feature representation of the target speech; and a speech recognition result determination module configured to process the target feature representation by using a speech decoding model to generate a speech recognition result of the target speech.

In some embodiments, the speech decoding model includes a language model.

The units and/or modules included in the apparatus 500 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 500 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more of the above methods may be performed by a suitable electronic device or a combination of electronic devices. Such electronic devices or combinations of electronic devices may include, for example, the electronic device 110 in FIG. 1.

FIG. 6 illustrates a block diagram of an electronic device 600 in which one or more embodiments of the present disclosure may be implemented. It should be understood that the electronic device 600 illustrated in FIG. 6 is merely illustrative and should not constitute any limitation on the functionality and scope of the embodiments described herein. The electronic device 600 shown in FIG. 6 may be configured to implement the electronic device 110 of FIG. 1 and/or the device 500 of FIG. 5.

As shown in FIG. 6, the electronic device 600 is in the form of a general-purpose electronic device. Components of the electronic device 600 may include, but are not limited to, one or more processors or processing units 610, a memory 620, a storage device 630, one or more communication units 640, one or more input devices 650, and one or more output devices 660. The processing unit 610 may be an actual or virtual processor and capable of performing various processes according to programs stored in the memory 620. In multiprocessor systems, multiple processing units execute computer-executable instructions in parallel to improve parallel processing capabilities of electronic device 600.

Electronic device 600 typically includes a plurality of computer storage media. Such media may be any available media accessible to the electronic device 600, including, but not limited to, volatile and non-volatile media, removable and non-removable media. The memory 620 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 630 may be a removable or non-removable medium and may include a machine-readable medium, such as a flash drive, magnetic disk, or any other medium, which may be capable of storing information and/or data and may be accessed within electronic device 600.

The electronic device 600 may further include additional removable/non-removable, volatile/non-volatile storage media. Although not shown in FIG. 6, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 is configured to communicate with another electronic device through a communication medium. Additionally, the functionality of components of the electronic device 600 may be implemented in a single computing cluster or multiple computing machines capable of communicating over a communication connection. Thus, the electronic device 600 may operate in a networked environment using logical connections with one or more other servers, network personal computers (PCs), or another network node.

The input device 650 may be one or more input devices, such as a mouse, a keyboard, a trackball, or the like. The output device 660 may be one or more output devices, such as a display, a speaker, a printer, or the like. The electronic device 600 may also communicate with one or more external devices (not shown) through the communication unit 640 as needed, external devices such as storage devices, display devices, etc., communicate with one or more devices that enable a user to interact with the electronic device 600, or communicate with any device (e.g., a network card, a modem, etc.) that enables the electronic device 600 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks of the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in one or more blocks of the flowchart(s) and/or block diagram(s).

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method comprising:
processing, by using a first speech encoding model, a speech feature representation of a speech sample to generate a set of discrete features;
generating label information based on the set of discrete features, the label information comprising a set of labels indicating a clustering center corresponding to a respective discrete feature;
processing, by using a second speech encoding model, an intermediate feature representation generated based on the speech feature representation to generate probability information corresponding to the label information;
determining a training loss based on the label information, the probability information, and weight information determined based on a distance from the respective discrete feature to the corresponding clustering center; and
adjusting a parameter of the second speech encoding model based on the training loss.

2. The method of claim 1, wherein determining the training loss based on the label information, the probability information, and the weight information comprises:
determining a cross entropy of the label information and the probability information;
determining, based on the weight information, a set of weighting coefficients corresponding to the set of labels; and
determining the training loss based on the cross entropy and the set of weighting coefficients.

3. The method of claim 2, wherein a target weighting coefficient corresponding to a target label is negatively correlated with a distance from the target label to a corresponding target clustering center.

4. The method of claim 1, wherein processing, by using the first speech encoding model, the speech feature representation of the speech sample, comprises:
generating, based on the speech feature representation, a plurality of segment feature representations corresponding to a plurality of segments of the speech sample; and
processing, by using the first speech encoding model, the plurality of segment feature representations to generate the set of discrete features corresponding to the plurality of segment feature representations, the set of discrete features comprising a result output by an intermediate layer of the first speech encoding model.

5. The method of claim 1, further comprising:
applying a target mask to the speech feature representation to generate the intermediate feature representation.

6. The method of claim 5, wherein the speech feature representation comprises a spectral feature of the speech sample.

7. The method of claim 1, wherein the first speech encoding model comprises a speech encoding model determined based on a stochastic discrete label pre-training process, and generating the label information based on the set of discrete features comprises:
determining a plurality of clustering centers by clustering the set of discrete features; and
determine the set of labels corresponding to the set of discrete features based on distances from the set of discrete features to the plurality of clustering centers.

8. The method of claim 1, wherein generating the label information based on the set of discrete features comprises:
determining the set of labels corresponding to the set of discrete features based on distances from the set of discrete features to a plurality of preset clustering centers.

9. The method of claim 1, further comprising:
processing target speech by using the second speech encoding model to generate a target feature representation of the target speech; and
processing the target feature representation by using a speech decoding model to generate a speech recognition result of the target speech.

10. The method of claim 9, wherein the speech decoding model comprises a language model.

11. An electronic device comprising:
at least one processor; and
at least one memory coupled to the at least one processor and storing instructions for execution by the at least one processor, the instructions, when executed by the at least one processor, causing the electronic device to perform operations comprising:
processing, by using a first speech encoding model, a speech feature representation of a speech sample to generate a set of discrete features;
generating label information based on the set of discrete features, the label information comprising a set of labels indicating a clustering center corresponding to a respective discrete feature;
processing, by using a second speech encoding model, an intermediate feature representation generated based on the speech feature representation to generate probability information corresponding to the label information;
determining a training loss based on the label information, the probability information, and weight information determined based on a distance from a respective discrete feature to a corresponding clustering center; and
adjusting a parameter of the second speech encoding model based on the training loss.

12. The electronic device of claim 11, wherein determining the training loss based on the label information, the probability information, and the weight information comprises:
determining a cross entropy of the label information and the probability information;
determining, based on the weight information, a set of weighting coefficients corresponding to the set of labels; and
determining the training loss based on the cross entropy and the set of weighting coefficients.

13. The electronic device of claim 12, wherein a target weighting coefficient corresponding to a target label is negatively correlated with a distance from the target label to a corresponding target clustering center.

14. The electronic device of claim 11, wherein processing, by using the first speech encoding model, the speech feature representation of the speech sample, comprises:
generating, based on the speech feature representation, a plurality of segment feature representations corresponding to a plurality of segments of the speech sample; and
processing, by using the first speech encoding model, the plurality of segment feature representations to generate the set of discrete features corresponding to the plurality of segment feature representations, the set of discrete features comprising a result output by an intermediate layer of the first speech encoding model.

15. The electronic device of claim 11, wherein the operations further comprise:
applying a target mask to the speech feature representation to generate the intermediate feature representation.

16. The electronic device of claim 15, wherein the speech feature representation comprises a spectral feature of the speech sample.

17. The electronic device of claim 11, wherein the first speech encoding model comprises a speech encoding model determined based on a stochastic discrete label pre-training process, and generating the label information based on the set of discrete features comprises:
determining a plurality of clustering centers by clustering the set of discrete features; and
determine the set of labels corresponding to the set of discrete features based on distances from the set of discrete features to the plurality of clustering centers.

18. The electronic device of claim 11, wherein generating the label information based on the set of discrete features comprises:
determining the set of labels corresponding to the set of discrete features based on distances from the set of discrete features to a plurality of preset clustering centers.

19. The electronic device of claim 11, wherein the operations further comprise:
processing target speech by using the second speech encoding model to generate a target feature representation of the target speech; and
processing the target feature representation by using a speech decoding model to generate a speech recognition result of the target speech.

20. A non-transitory computer-readable storage medium having stored thereon a computer program executable by at least one processor to implement operations comprising:
processing, by using a first speech encoding model, a speech feature representation of a speech sample to generate a set of discrete features;
generating label information based on the set of discrete features, the label information comprising a set of labels indicating a clustering center corresponding to a respective discrete feature;
processing, by using a second speech encoding model, an intermediate feature representation generated based on the speech feature representation to generate probability information corresponding to the label information;
determining a training loss based on the label information, the probability information, and weight information determined based on a distance from a respective discrete feature to a corresponding clustering center; and
adjusting a parameter of the second speech encoding model based on the training loss.
